(19) United States
(12) Patent Application Publication
(10) Pub. No.: US 2025/0111548 A1
(43) Pub. Date: Apr. 3, 2025

(54) STREAMLINE DATA COMPRESSION USING 4D SYNTHETIC MODELS

(71) Applicant: TRL11, Inc., Irvine, CA (US)

(72) Inventors: Nicolaas Verheem, Laguna Hills, CA (US); Ryan Barber, Aliso Viejo, CA (US)

(73) Assignee: TRL11, Inc., Irvine, CA (US)

(21) Appl. No.: 18/900,315

(22) Filed: Sep. 27, 2024

Related U.S. Application Data
(60) Provisional application No. 63/586,271, filed on Sep. 28, 2023.

(51) Int. Cl. G06T 9/00

(52) U.S. Cl. CPC G06T 9/001

(57) ABSTRACT

Video compression method and apparatus wherein a scene image is captured and compared to an expected scene image that was generated based on a computer-modeled scene and wherein the difference data—if any exists, is transmitted and/or stored, thereby reducing the requisite bandwidth and/or storage space. Optionally, difference data that is considered unimportant can be ignored or otherwise omitted from transmission and/or storage. Embodiments of the present invention can replicate all or a portion of real-world camera or other sensor and scene characteristics, preferably using predictive modeling and adaptive analysis, to efficiently encode and transmit video data. Embodiments of the invention thus encompass methods for scene reconstruction, object tracking, parameter updating, and/or bandwidth-adaptive streaming, with particular applications in space-based imaging and video processing.

### CROSS-REFERENCE TO RELATED APPLICATIONS

This application claims priority to and the benefit of the filing of U.S. Provisional Patent Application No. 63/586,271, entitled “METHOD TO STREAMLINE VIDEO COMPRESSION”, filed on Sep. 28, 2023, and the specification and claims thereof are incorporated herein by reference.

### BACKGROUND OF THE INVENTION

Video compression is fundamental to a large number of wide ranging applications in almost every aspect of modern life. Video compression typically works by either: (1) removing visually unimportant or redundant data from within a single frame of video (i.e. a still image). This is commonly called intra frame or spatial compression and may also include further simplifying or encoding the remaining data in a highly effective pattern (e.g. entropy encoding). Examples include MJPEG, JPEG2000, Wavelet compression. (2) removing data from within a sequence of frames, that is visually unimportant or redundant because it repeats unchanged over many frames. This is commonly called inter-frame or temporal compression. (3) a combination of techniques used in the above.

Temporal compression has grown in popularity over spatial compression due to the former's greater efficiency: Because most video scenes often comprises 60 frames per second that contains a large amount of data that does not meaningfully change from one frame to another (e.g. the background in a scene containing a person talking into the camera), it is quite redundant to send this background information in full, over and over again with each frame. Hence in temporal compression, after compiling a single reference frame (Called I-Frame or Key Frame), the difference between this frame and subsequent frames are determined (by “subtracting” frames), and then only the differences are stored or transmitted (called P frames). However, because of inaccuracies in determining the P-frames, or due to e.g. quantization/rounding, the error in reconstructed frames (i.e. the sum of reference I frame and differential P frames) build up over time. Thus, a fresh I-Frame is commonly captured and sent again, every so often. This repeating combination of I-frame, and several P-frames, are called a Group of Pictures (“GOP”). As an example, if the rate of the video is 60 frames per second, a GOP may typically represent two seconds of video and contain a single I-frame and 59 P-frames. Practically It is quite common that the I-Frame requires the same storage or bandwidth requirements as all the 59 P-Frames put together. In other words, the I-frame, although only representing 1/60 of the duration of the GOP, requires a full ½ of the bandwidth and/or storage space of the GOP. It is therefore attractive to target the I-Frame for optimization, instead of further refining the p-frames.

Existing video compression techniques often struggle to efficiently handle complex, dynamic scenes, particularly in bandwidth-constrained environments such as satellite imaging. Traditional methods may unnecessarily encode high-frequency details that are perceptually insignificant while failing to accurately represent more important scene elements and their transformations over time. High-frequency textures like ripples on water surfaces consume significant bandwidth without adding meaningful information to the viewer. Scenes with a high degree of background motion, combined with a high degree of motion, such as scenes captured from a camera on a moving platform e.g. an airplane, drone or satellite really struggle.

There is thus a present need for a data compression method and apparatus that greatly reduces the data transmission and/or storage requirements in comparison with conventional compression methods. There is especially a present need for a video compression method and apparatus that greatly reduces the data requirements of the I-frame in conventional compression methods.

### BRIEF SUMMARY OF EMBODIMENTS OF THE PRESENT INVENTION

Embodiments of the present invention relate to a data compression method including obtaining a representation of an actual scene with a sensor, generating a representation of an expected scene with a model, comparing the representation of the actual scene with the representation of the expected scene, and obtaining difference data from the comparison, the difference data representing a difference between the representation of the actual scene and the representation of the expected scene. Obtaining difference data comprises ignoring differences between the representation of the actual scene and the representation of the representation of the expected scene that are determined to be unimportant information. Unimportant information can include high-frequency, low-relevance texture data. The method can include replacing at least some of the unimportant information with representative texture data that is pre-modeled and pre-stored.

In one embodiment, at least some of the difference data can be used to form a region of interest, that is a subset of the generated representation of an expected scene, for subsequent compression using either intra-frame compression or inter-frame compression in a temporal compression method. The method can also include storing or transmitting at least some of the difference data. In one embodiment, the method does not include transmitting or storing an entirety of the representation of the actual scene when the difference data does not include the entirety of the representation of the actual scene. The method can also include decompressing data by receiving or otherwise obtaining the at least some of the difference data and creating a recipient-generated representation of the expected scene with the at least some of the difference data, at least some metadata that describes how difference data was obtained, and a prior copy of the model. In one embodiment, the at least some of the difference data does not include difference data that was determined to be unimportant information. The method can also include applying indicia on or about an area of the recipient-generated representation of the expected scene to highlight or otherwise identify the at least some of the difference data.

Optionally, generating a representation of an expected scene can include using a 3D rendering engine that models the sensor. Generating a representation of an expected scene can include using a 3D rendering engine that models the characteristics of the representation of the actual scene. Generating a representation of an expected scene can optionally include applying or otherwise accommodating one or more of sensor resolution, frame rate, exposure time, sensor type and/or a combination thereof. The method can also include updating the model. Optionally, generating a representation of an expected scene with a model can include generating a representation of an expected scene with a model for a predetermined application, wherein the model is constructed with one or more predetermined likely to be present objects and shapes and wherein the predetermination comprises not choosing objects or shapes that are not likely to be encountered in the predetermined application.

Embodiments of the present invention also relate to computer software stored on a non-transitory computer readable medium for data compression including code obtaining a representation of an actual scene with a sensor, code generating a representation of an expected scene with a model, code comparing the representation of the actual scene with the representation of the excepted scene, and code obtaining difference data from the comparison, the difference data representing a difference between the representation of the actual scene and the representation of the expected scene. In one embodiment, code obtaining difference data can include code ignoring differences between the representation of the actual scene and the representation of the expected scene that are determined to be unimportant information. The software can further include code that determines that high-frequency, low-relevance texture data is unimportant information. The computer software can also include code storing or transmitting at least some of the difference data, and/or code decompressing data by receiving or otherwise obtaining at least some of the difference data and code creating a recipient-generated representation of the expected scene with the at least some of the difference data and the model. The computer software can also include code applying indicia on or about an area of the recipient-generated expected scene to highlight or otherwise identify the at least some of the difference data.

Embodiments of the present invention provide a novel approach to video compression and enhancement, by utilizing a highly descriptive, dynamic 4D model of a scene, and optionally a 3D rendering engine. This pre-emptively recreates all the visually important features, or even an exact pixel by pixel replica of the 2D image a real-world camera or other measurement apparatus is expected to see, given the objects, scene lighting, and camera characteristics described in the 4D model, ahead of time. An actual 2D image is then also captured or measured using a real-world camera or other measurement apparatus. The expected or 2D modeled image (“Mo”) is compared to the actual captured or measured 2D image (“Me”), using one or more computer vision approaches. Unexpected or surprising content in the scene is grouped together and treated as a Region of interest (“ROI”), while noise induced by the comparison is filtered out. By pre-emptively modeling expected scenes and camera parameters, comparing it to actual measurements, and then extracting and compressing only surprisingly different content as an ROI, the system intelligently transmits only the scene content significantly contributing net new information, while elegantly completely bypassing the need to transmit any information contained in a compressed video stream as a result of predictable motion of predictable objects.

Continuous feedback and adaptive analysis can optionally be used to refine the 3D scene model, allowing for efficient encoding and transmission of video data over extended periods. Embodiments of the present invention also provide for representative reconstruction of the complete scene at a remote receiver location, from a synchronized digital twin of the same 4D model, which is then overlayed with the actual pixels from the ROI that was transmitted. This allows the remote viewer to retain the full context of the whole scene, even if only a small part was transmitted. It also allows for hyper-realism, where modeled parts of the scene can be rendered to a higher resolution, or with more favorable lighting, than what was actually captured. Embodiments of the present invention also offer Object tracking, parameter updating, and bandwidth-adaptive streaming, with particular applications in surveillance, space-based imaging, product inspection, and other fields requiring efficient, high-fidelity rendering in dynamic environments.

By implementing a 4D model, that models real-world objects, scene lighting characteristics, and the camera's sensor properties, the method and system can predict a significant portion of the captured frames in advance, and simultaneously in more than one location, obviating the need to transmit that information. By then focusing all resources on and transmitting only the important differences between the expected frames and the actual captured frames, a significant reduction in the bandwidth required for transmission and/or in the requisite storage space for the data can be achieved. Advanced analysis techniques are preferably incorporated to continuously refine the scene model, adapting to new objects and changing conditions. Embodiments of the present invention are thus ideal for telepresence applications where efficient, high-fidelity observation of remote content is important and/or applications where a user or system is monitoring for small variations in an expected scene, such applications can include for example product inspection, surveillance, space observation, live event broadcasting.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a drawing that illustrates a system block diagram of the of a video and/or image compression method according to an embodiment of the present invention;

FIG. 2 is a system block diagram of decompression method that can be used according to an embodiment of the present invention;

FIG. 3 is a drawing that illustrates an overall process flow diagram from obtaining data of the measured frame, the process for compressing it, transmitting it to a decoder engine for reconstruction; and

FIG. 4 is a drawing that illustrates data flow through an embodiment of the present invention.

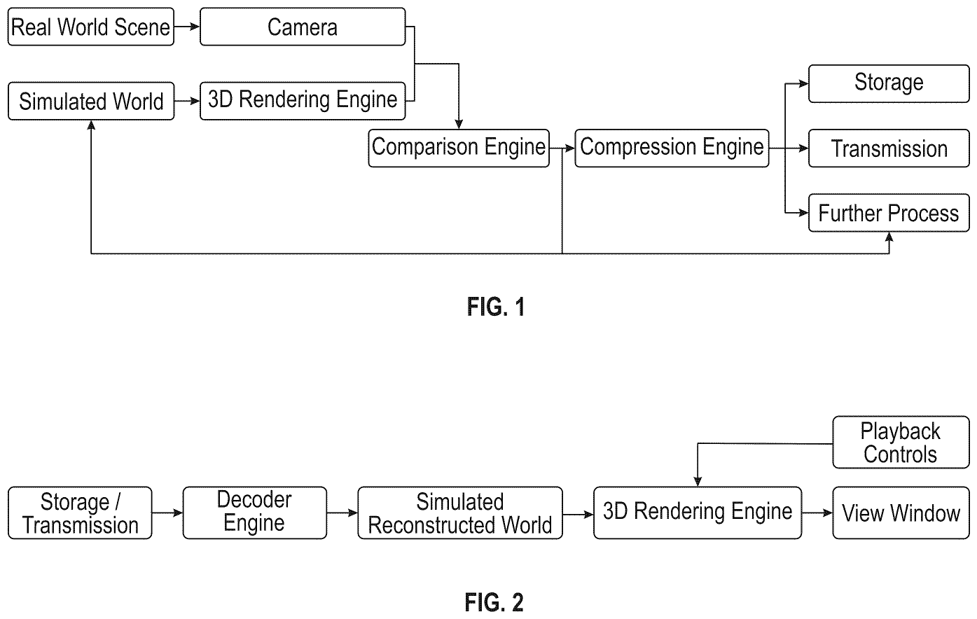

### DETAILED DESCRIPTION OF THE INVENTION

Referring now to the figures generally, embodiments of the present invention preferably greatly reduce the data requirements for transmission and/or storage of image data or a sequence of images' data. This can be especially helpful in compressing or otherwise reducing not only image data but also video data. Although the examples used refer to cameras, and visual images, the image can also be generated from Infrared, X-Ray, radar sensors, or any other desired sensor type or a combination thereof. Embodiments of the present invention can be used to compress or otherwise reduce the amount of data contained in the I-frames, and in particular can eliminate the need for P-frames, or reduce the size of the P-frames resulting from predictable scene behavior. The methods can also be used with conventional or other video compression techniques and retain interoperability with existing video transmission systems. As used herein, the term “compression” is intended to include the act of reducing a requisite amount of data transmission and/or storage. Thus, embodiments of the present invention which rely on a recipient, receiver, or decoder having access to a digital twin and other scene data in order to interpret transmitted and/or stored data by using a smaller amount of data than would otherwise be required for transmitting and/or storing an image is intended to be understood as data compression. Throughout this application, reference is made to an actual scene and a scene generated from a 4D model, when referring to the “actual scene” it is intended to mean a representation of the actual data obtained from a camera, or other sensor which is recording data indicative of a physical object(s) and/or environment. Likewise, the representation that is generated by the model against which the actual scene is compared need not be limited to a portion of a video recording, but can also include an image and/or other data which result from modeling the one or more sensors that are used to capture or otherwise record the actual scene. The term “camera” as used throughout this application is intended to include not only one or more still image cameras but can also include one or more video cameras and/or a combination of one or more still cameras and one or more video cameras, Xray, Radar, Lidar, or Time Of Flight (“TOF”) sensors. As used throughout this application, the term “sensor” is intended to include a camera, video camera any other sensor, apparatus, or device capable of obtaining data that can represent an actual scene. Although the specification makes several references to the use of a “camera” in describing embodiments of the invention, it is to be understood that such description is merely illustrative, thus other sensor types and/or combinations thereof can be used in such context. Optionally, creating a mode can include creating a representation of an expected scene.

Embodiments of the present invention preferably include creating a detailed 4D model of the scene to be captured by a sensor. The model accounts for predictable elements, including geometric features of objects, and their motion, and all lighting conditions describing the scene. By modeling the scene, extracting a representation of an expected scene at any given time, and then comparing it to a captured representation of the actual scene, the predictable elements, which were modeled, can be removed so that only the difference or delta data between the model and measured scene is obtained—the difference data representing only the unexpected data captured by the sensor, not the expected data capture by the sensor. This difference or delta data can then be stored or otherwise transmitted to a decoder, along with the actual time, and camera characteristics that resulted in the delta. The decoder has access to the same 4D model that was originally used—for example, the encoder and decoder synchronize their model before the transmission of the delta data. Then, the decoder recreates the exact same expected scene, and preferably adds the received delta data to its modeled data to recreate or at least substantially recreate the scene that was captured by the sensor. This approach reduces bandwidth usage drastically, as the system no longer wastes resources on transmitting highly predictable and thus redundant information. In one embodiment, the one or more sensors are preferably synchronized with the model or otherwise associated temporally.

Embodiments of the present invention can use a three-dimensional (3D″) rendering engine that models real-world sensor and scene characteristics in real-time into a 3D image. This approach allows for intelligent video compression by transmitting only the important differences between the rendered 2D prediction and the actual 2D captured frame, along with optional continuous feedback adjustments to the 3D scene parameters. The system and method may incorporate advanced analysis techniques to continuously refine its model of the scene, adapting to new objects and changing conditions, making it ideal for applications in surveillance, space observation, and other fields requiring efficient, high-fidelity rendering in dynamic environments.

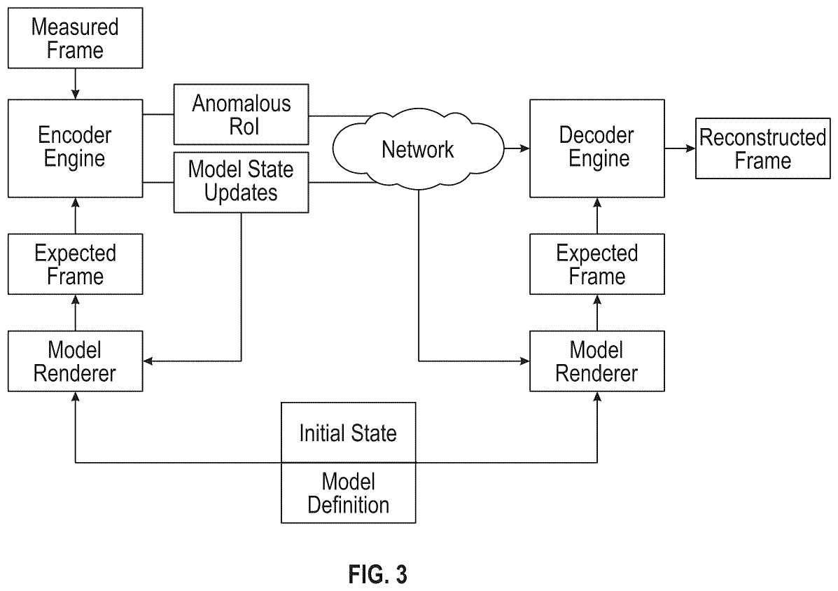

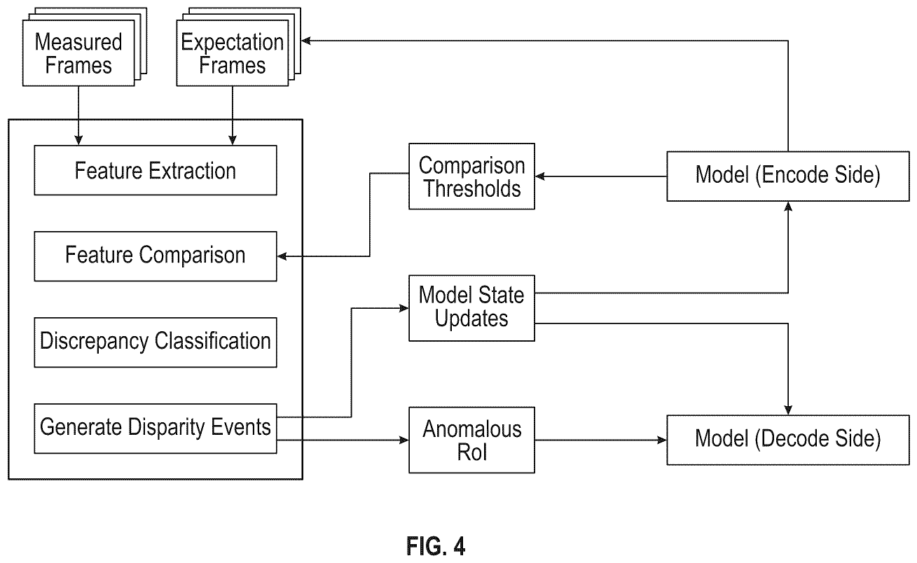

Referring now to FIGS. 3 and 4 in particular, the following discussion describes some of the terms illustrated therein, followed by a detailed description of a workflow for setting up and using an embodiment of the present invention to compress data at an encoder, transmit it to a receiver (also referred to herein as a decoder), and to the extract the compressed data.

Feature Extraction: Involves capturing deep, descriptive features from both the rendered frame and the corresponding camera frame. These features can be obtained, for example, by passing the frames through neural networks such as Convolutional Neural Networks (“CNNs”) or Vision Transformers. The intermediate activations of these networks provide feature vectors that describe different regions of the image. These vectors capture information at multiple semantic levels: shallow features represent basic elements like edges, gradients, and structures, while deeper features encapsulate more complex representations, such as objects or scene elements. The depth of the feature extraction process can be adjusted based on the scene content, allowing for fine-tuned analysis of different regions.

Feature Comparison: Refers to comparison performed between the extracted features of the rendered frame and the measured frame. The comparison process references different thresholds of difference associated with different regions of the image, based on the predefined importance of the objects and textures within those regions. For instance, comparisons of grass or water textures, which contain fine but often insignificant details, occur at a deeper semantic level and may have high thresholds, meaning variations in texture (as long as it is still grass) are ignored. On the other hand, objects of higher relevance, such as a bird that lands on the grass, are given lower thresholds of difference. This ensures that important or anomalous changes—such as the splash from a fish—are accurately captured and flagged, while less important regions, like background textures, can be masked out or deprioritized.

Discrepancy Classification: Refers to the process of interpreting detected differences between the model's predicted scene and the real-world captured scene. In a nominal state, there should be no differences, but when discrepancies occur, they are either classified as a type of Model State Update, or an Anomalous Region of Interest. For instance, the appearance or disappearance of objects leads to significant and deep feature-level differences concentrated to a tight region, signaling that the model needs to account for object additions or removals. Spatial or temporal misalignment of objects suggests shifts in their positions or motion, while pixel-level and lower-level feature differences often indicate changes in lighting, texture, or orientation. By analyzing these discrepancies, the system can determine what updates are needed—for example adjusting object positions, lighting, or camera parameters to realign the model with the actual scene. If the discrepancy is unable to be described as a transformation applied to the model, then the difference is described using pixels and transmitted as an Anomalous Region of Interest.

Generate Disparity Events: Refers to the process of taking the discrepancies identified during discrepancy classification, packaging, and transmitting them to local and remote models as Model State Updates or Anomalous Regions of Interest.

Model State Updates: Refers to the compressed description of specific state adjustments that must be made to the predictive model to realign it with the real-world scene. These are based on the discrepancies identified during the comparison process. These updates represent transformations such as object movements, additions, removals, or changes in lighting, texture, or orientation.

Comparison Thresholds: Refers to the predefined criteria used to determine when a detected difference between the predicted model and the real-world scene is significant enough to trigger a Model State Update, or an anomalous Region of Interest. These thresholds can vary across different regions of the scene and are adaptive based on the semantic importance of the area being analyzed. In practice, thresholds are multidimensional, with different levels for different levels of semantic depth.

The threshold system can be fine-tuned to prioritize the level of detail required for each scene region. Shallow semantic levels, such as pixel and edge comparison, might have higher thresholds in unimportant regions but tighter thresholds in areas where objects of interest are located. Deeper semantic features, like object shapes and classifications will typically have less lenient thresholds, but can be lowered if, for example, only a particular region of the scene is of any interest.

Anomalous Region of Interest (ROI): Refers to a specific part of the captured scene where significant and unexpected changes have been detected. These regions can be identified through the feature comparison process and can represent discrepancies from the predictive model that cannot be described as a transformation to the model. Typically, these regions would represent a new and unexpected object that has been detected. In a space application, it could represent the detection of an adversarial satellite. In a security application, it could represent an intruder that has been detected.

To implement an embodiment of the present invention, first, a detailed 4D model of a scene is created, which attempts to describe an exact replica of any moment or period in time in actual reality, captured by an arbitrary sensor, from any arbitrary viewpoint. The model includes all objects, their geometric properties, the colors, surface textures, etc. the lighting conditions, and the expected movements of the objects. Examples of object sets can include stars, planets, satellites and the sun. Another can include buildings, landmarks, trees along a road. A third can be soda bottles moving along a production line. In all cases, the lighting conditions of the scene are simulated using a description of the light sources, their locations, brightness, diffraction, etc. Finally, a physics model describes the behavior of the light (for example reflections) and the movement of the objects (orbits, driving along the surface of the road, a conveyor belt moving), as well as the movement of the camera, over time, if any. This model will then be able to create an image or a sequence of images (for example a movie) spanning any arbitrary time, from any arbitrary viewpoint (camera location). This model attempts to describe all the information, behaviors, and characteristics of a selective part of actual reality, and is often called a digital twin.

Given the emphasis on predictable scenes, the model does not have to describe every possible object in every possible location, or every possible light source, all at once. It only needs to describe the most likely ones. For example, it is extremely unlikely a camera will ever capture a dolphin illuminated by a disco ball while in orbit, so the digital twin does not have to contain descriptions of dolphins or disco ball light sources, if the scene involves a camera in orbit.

Given the high degree of planning of a mission to space, a high volume production plant, or even a car driving the same route every day, the digital twin can be installed on or uploaded to the encoder side, which can be at or near where the camera is hosted, before departure.

Importantly, both end points (the encoder and the decoder) preferably contain highly accurate timekeeping abilities. If the camera ever moves in an unplanned way (a satellite's orbit is changed, or a car takes a detour), the expected scene is simply updated by retrieving a new 2D image from the 4D model with the new location, orientation, and time, on both the encoder and decoder side of the model.

When the encoder compares the initial images from the model to the first image measured, some calibration may be required. By registering recognizable key points in the two images, it can easily be determined if the image is correctly positioned, rotated and scaled. It may also be necessary to adjust the time used to extract 2D images from the 4D model. Once the macro full image alignment is done, any moving objects within the scenes is analyzed for proper positioning within the frame. If the full image is properly aligned, but the moving object is out of place, it is most likely the time, and not the position that is misaligned. The exact synchronizations between the model and the reality can now be determined by extracting (which can include rendering) sub frames from the model, until proper alignment is achieved. It may be necessary to adjust the physics model of the object movements at this point. Embodiments of the present invention can function with either the actual scene observation occurring first (such that the actual scene observation is made and then the model is generated), or with the data from the model being obtained before the actual scene observation is made.

Once the 2D image is extracted, aligned with the measured 2D image, and the time between the model and reality is synchronized, calibration is done and the expected image is compared to the actual image using one of several machine vision methods like direct pixel comparison, Mean Squared Error, Peak Signal to Noise Error, Color Histogram, Chi Square, Structural Similarity, Feature Transform, Fourier transform, Wavelet transform or Artificial Intelligence (“AI”) techniques like Convoluted Neural Networks, Transformers, Hashing, or Optical Flow. The choice can be determined based on prior understanding of the scenario, or on real time performance, available computer, power consumption, or expected accuracy. More than one comparison method can also be performed, iteratively or sequentially, if time allows. The combination and sequence can be tailored and trained over time to yield progressively more accurate results.

The result is a heat map or disparity map, which will most likely still contain false positives, or noise. Filtering techniques can be used from this point forward, based on for example total energy concentrated per area, movement of spread and centroid of objects, tracking of objects, etc. The filtering can be progressively increased to remove more and more noise until only a few areas or only a small area of the heatmap pokes through the noise floor. The areas of the image that remains are considered positive detections, and are group and simplified into a few simple shapes, that are treated as Regions of Interest going forward.

The region of interest is then applied as a mask to the actual measured image, cropping out only those pixels in areas designated ROIs. The ROIs can now be compressed and transmitted or otherwise stored using any proprietary or standards based compression algorithm (for example advanced video coding (“AVC”), high efficiency video coding (“HEVC”), AOMedia Video 1 (“AV1”), combinations thereof and the like). The key information about the image captured are sent along with the ROIs. This could include for example exact time, camera settings, exact orientation location of camera in actual 3D space, alignment, rotation or scaling that had to be done to get the images from the 4D model and from 3D space to align.

With the actual pixels transmitted as an ROI, the exact method and parameters used to extract the image from the 4D model, the decoder can now recreate an exact photorealistic copy of the actual full image that was captured, even though it only required a fraction of the pixels to be encoded. Optionally, the encoder and the decoder can be one-in-the same unit and need not be physically separated from one another. For example, if a particular application merely requires generating, storing, retrieving and using data at a single location then a single encoder/decoder unit can be used to effectively compress data before it goes into storage and to then extract the compressed data when it is removed from storage.

If one or more ROI is triggered repeatedly in the same or very similar locations, analysis is preferably performed to determine if the model has permanently changed (for example a piece fell off, deployed, or a new feature like a building was permanently added to the scene. If this is determined to be the case, the model is preferably updated, and the model updates must be communicated to the decoder. Once again, the update will be described as a combination of geometric shapes, textures, light sources and movements. And once again, the description for a potential disco dolphin does not need to be included if the scene does not involve an aquatic themed disco party. In fact, most additions and their features can be represented well by greatly simplified models with a good understanding of the scenario, analogous to downloading only detail on small part of a map relevant to the user's current location.

If any of these parameters do not have predictability from prior knowledge, or from real-time relayed updates, then additional analysis can be performed on the camera captured frame in order to update the predicted properties of these objects, lights, and camera in the 4D modeled scene accordingly. More information about 4D model updating is provided below.

Embodiments of the present invention preferably provide object texture rendering within the model, which can include detailed texture maps that simulate expected objects with diffuse, ambient, emissive, and specular components. This can be done by the engine, which can preferably incorporate geometry data with normal, displacement, and bump maps for realistic surface details, thus enhancing the visual fidelity of the rendered scene. For example, some background and/or foreground textures might be complex and have a lot of detail that is not important for a given application because the value of that detail in a given application is extremely low; for example, the grass on a sports field is extremely detailed, however its unique texture for any given section is irrelevant to the sport.

Dynamic object movement can be modeled to include real-time translation and rotation of objects in X, Y, and Z axes, along with their respective light and sensor positions, with the capability to adapt as scene conditions evolve. The model can preferably adapt to changes in object positions and orientations, ensuring that the rendered scene remains synchronized with the representation of the actual scene.

Thus, any high quality fairly matching grass texture can be used in place and a fan would not notice/care. Similarly, the changing generic details of the ripples on a pond, ocean, or lake are high frequency high bitrate details, but to the viewer they are irrelevant and thus differences which exist between the model and the original image need not be transmitted or stored. However, if something creates a splash in the water, that is significant. So, the importance of the water details can be condensed to include ripple amplitude, frequency, and direction, rather than per pixel change in the water surface from the original capture.

In frames of images obtained in space, there is a high probability that newly detected objects will have a very predictable structure, which can include, for example, one or more of:
Rectangular prism (satellite body);
Cylindrical prism (satellite body);
Flat rectangular planes (satellite solar panels);
Disks (solar panels, parabolic dishes, combinations thereof and the like); and/or
Spheres (star field, planets, moon, sun, other simple satellite structures).

Similarly, in space, there is a high probability of certain textures (solar planes, colors like black, silver, white, gold or other metallic color, gray, or matt finishes or otherwise surfaces that resemble foil). Planets also have expected constant texture; however, the Earth's weather and varying cloud structure will of course change. Thus, the geometry, texture, and material database for space objects can be extremely predictive. In restructuring the geometry of the objects, they can also be defined as a composite of these different base geometries and textures. If these geometries are human made satellites, then other predictions can be made about the geometry, which can include for example predicting or otherwise assessing:
A principal axis to determine the 1st, 2nd, and 3rd axes for predictive rotation control;
Navigation capability based on thruster detection;
Thruster fuel tanks and assessing volume, mass, and the threshold of its ability to change velocity;
Electrical power capability by the size of its solar panels;
Equipment sensitivity to sun shielding; and/or
Rotation—for example if the satellite or other object is rotating with respect to its trajectory around earth, then it's likely “looking” at Earth.

In one embodiment, the method only stores or transmits the camera-captured information that does not match within the bounds of important differences between the 3D rendered frame and the camera captured frame; and to also have a comparison analysis between the rendered frame and the camera captured frame that can update the characteristics of the estimated global time, the global rate of time, the respective positions and rotations of objects (their paths, trajectories, combinations thereof and the like), the position and rotation of the camera (and its path, trajectory, combinations thereof and the like).

Methods of frame comparison analysis for updating the parameters of the 4D model to best match the 2D real world image frame can include updating the 4D model with one or more of:
A global time offset adjustment and rate adjustment when all objects are similarly off in time and/or rate;
Update of respective 3D objects in translation and rotation that no longer matches the global time estimated parameters for that specific object when compared to the other predicted object parameters;
Update path time offset;
Update acceleration, velocity, position, torque, and/or rotational velocity;
Update objects mass (which can be, for example relevant for acceleration calculation when using fuel);
Adding new objects to the model;
Geometry, texture, translation, and/or rotation;
Assessing what the object might be from unexpected view in the scene;
Assessing its relative 3D position based on 2D translation speed with respect to other objects;
Assessing its 3D geometry from view angles changing over time;
Analyze by edges, curves, planes, angles, and gradients;
Accumulate the texture info over time to build a texture mapping for the 3D geometry (this can optionally start as a flat sprite region); and/or
Assessing, adding, or removing of lights and their respective parameters over time as well utilizing additional one or more cameras (either on the same object or on a different object) to build on by adding or removing objects to the model, or fine tuning the geometry, location, or rotation of the objects through parallax. Checking for a change in translational or rotational trajectories across time delta between one or more cameras.

Embodiments of the present invention can also preferably remove objects from the model when they don't show, or no longer show in the camera captured frame when they were predicted to. Embodiments of the present invention also use a segmentation and/or classification convolutional neural networks (“CNN”), or a plurality of CNNs, which can assist with new object verification and identification; if identified and already available in the model object database, then utilize accordingly—update other parameters (for example, color) accordingly. Chroma segmentation can also be used beyond connected edge detection to assist with segmentation. Thresholds of rotational or translational change over time can be used for considering whether the rotational or translational change constitutes important data that should be transmitted or otherwise stored.

Embodiments of the present invention preferably continuously refines the 3D scene model by comparing the 3D simulated world objects and their respective properties along with the simulated camera properties (most preferably per every 3D rendered frame) to that of the corresponding real world objects identified and characterized from the camera captured frames. These updates can include:
Parameter updates, wherein differences between the rendered and captured frames lead to updates in global time, object paths, rotations, velocities, and the introduction of new objects into the scene.
Predictive modeling, which utilizes predictive models for object movement, especially for rigid bodies with predictable paths (for example satellites in known orbits or products passing through a production or inspection line). This minimizes real-time computational overhead and allows for efficient updates.
Real-Time object identification wherein new objects detected in the scene are analyzed, and their geometry and textures are accumulated over time. Predictive algorithms assist in recognizing expected shapes and textures, enhancing the accuracy of the 4D model.

These updating methods can be implemented with feedback loops that can dynamically update the model when repetitive anomalies are detected, further optimizing the system and helping the model to better match the representation of the actual scene as captured by a camera or other sensor. For example, if a camera repeatedly detects certain lighting conditions or a dead pixel, this can be feedback and the model or even the noise floor can be adjusted to account for these consistent differences. This method can also be used to control camera parameters which can include for example exposure or focus dynamically. By predicting what will enter the frame next, the system can pre-adjust settings to optimize image capture, avoiding common issues like blown-out images when sudden lighting changes occur

Object identification from the camera frames can be achieved by using a CNN or other computer vision methods for segmentation and classification; using computer vision techniques which can include for example optical flow for associating segmented and classified objects with the respective objects relative scale, position, velocity, and rotation; and/or using computer vision techniques—for example the Hough Transform in association with segmentation and gradients within these segments to determine flat planes, curved surfaces, and general geometry of the segmented objects. The geometry of objects can be further refined with temporal interframe parallax with optical flow techniques. There are also other depth mapping techniques that can be used, including using depth reconstruction CNNs. Optionally, artificial intelligence can be used to generate texture or other high-frequency low relevance scene data. Optionally, this can be done by providing a text-based description of the high-frequency low relevance scene data.

After the foregoing object identification steps, texture UV mapping is then performed via projection from the segmented object pixels to the associated geometry vertices as previously determined. Through temporal interframe updates, the texture can be further refined.

Frame comparison analysis is then preferably performed between the 3D rendered frame and the corresponding camera frame. In one embodiment, deep features can be extracted from the 3D rendered frame and the corresponding camera frame by passing the frames through networks which can include for example one or more CNNs or Vision Transformers. The intermediate activations of the networks give descriptive feature vectors that can be used to compare regions at a semantic level. Differences can be computed between regions of the image at varying levels of semantic “depth”. “Deep” features describe regions as objects, shallow features can describe edges, gradients and structures, and at the most shallow level, pixels can be compared directly. The semantic “depth” the comparison occurs at can be configured by the scene content. For example, comparison of blades of grass on a field should be performed at a “deep” semantic level, whereas comparison of written text should occur at a more shallow level. Regions can be marked as “anomalous” when the difference between the feature vectors exceeds a threshold. The threshold of difference required can be guided by the predefined importance of various objects and their associated textures, ensuring that more relevant areas are prioritized during the comparison process. For example, objects that have textures like grass or water surfaces might have substantial fine details in differing blades of grass or ripples in the water, but given that these details might be considered of low importance to the viewer, they can have high thresholds of difference, or even be masked out altogether. By comparison though, a fish jumping out of the water, or a bird landing on the water could be considered to be of high importance, and thus the splash of the fish or the bird on the water would have a very low difference threshold. Accordingly, determinations of what is considered “important” can be decided individually for each particular application or implementation to ensure that information that is considered important in that particular application or implementation is accurately distinguished from unimportant data.

If all objects exhibit a uniform temporal offset, the system can adjust the global time or rate accordingly. For in cases where only one or some, but not all of the objects in the frame are deviating from their expected paths or rotations, the system preferably updates translations, velocities, accelerations, and rotational parameters for that individual object or that subset of objects. When new objects are detected, their geometry and textures are preferably incrementally built by analyzing changes over time, starting from simplified shapes to more detailed models.

Hyperrealism or Super resolution rendering becomes possible for the known predicted regions. In one embodiment, the decoder of the method and apparatus preferably has the ability to change the view angle for known parts of the scene; for unknown parts, as the real-time analysis builds a new representation of the new objects geometry, texture, trajectory, and/or rotational velocity, its 3D reconstruction in the decoder preferably gains accuracy and positioning, and can then be reversed in time to build on the unknowns when it was first detected. By also then updating the model, it can then gain super resolution in geometry and texture, and then be previewed from multi angles in the decoder. For example, before or during playback of the model, a user can choose to rotate the view of the model with the important difference data applied thereto so that the user is viewing the image or video from a different angle. It is also possible then to view beyond the camera video capture region based on predicted paths over time; these objects, when viewed outside the camera capture area, can be shown in a forward and backward estimate of confidence of their respective positions and rotation in 3D space. That confidence of trajectory over time (either shown with blur or a confidence level or a coloration of confidence or a vector path trumpet of likelihood of being) can be revalidated if the camera comes back to view the object or if another camera does afterwards—this would change the trumpet error potential to an eye shape or single predicted line/point.

The 3D rendering can also be updated on the decoder to be more easily viewable by normalizing overly bright or overly dark scenes (or totally changing lighting for a different time of day for example), enhancing colors, intentionally giving false color for depth or object categorization, or for emphasizing specific objects by classification, or for showing objects trajectories forward and backward. The decoder can also provide the ability to select and/or highlight different objects for post analysis and post processing.

In one embodiment, for compressing the image or video, one or more agreed upon object types library and their textures and other parameters can be shared between the encoder and the decoder. The library can also contain known motion and rotation paths over time, thus reducing the need to transmit this data. In one embodiment, this preferably occurs as a preliminary setup and before the important difference data is transmitted or otherwise recalled from memory or storage. In one embodiment, objects and their parameters are preferably indexed (for example using Huffman encoding), prioritizing transmission based on the frequency and importance of changes. New or unidentified objects are preferably given unique identifiers and are gradually modeled over time, improving compression efficiency as more data becomes available.

The decoder preferably decodes the streamed/recorded 3D descriptions of the objects in the scene, including their respective geometry, textures, and properties, and then places the objects in the simulated 3D world at and for that given time. The decoder also preferably decodes the camera and lighting properties from the streamed and/or recorded camera description, and then renders the scene with the simulated camera accordingly. Lastly, the same significant differences between the camera frame and the rendered frame determined by the encoder side that were streamed and/or recorded is then also applied to the decoder rendered frame. In other words, the decoder also generates the synthetic model on its side, ensuring that the transmitted data can be reintegrated seamlessly to maintain context. This allows the final image or video to include both the model and the real-time measurement of the unpredictable changes. By reassembling the scene, the system maintains full context for the transmitted differences.

Multiple of the same object type are preferably uniquely indexed from a preset known index identity, or if newly identified or not yet matched, is preferably assigned a different identity (“UID”)—for example an identification of “yet to be identified”—these UIDs can then be converted to a known identity if and when it is validated as such. This can happen across multiple cameras as well when trying to link an unknown UID to a known identity, or two unknowns to be the same unknown. Unknown objects can have their texture and geometry built up over time—to either be classified as a recognized object type, or as a new unique object type.

Preferably, all objects, lights, and cameras have translation and rotation parameters assigned and stored or otherwise attributed to them within the model and/or databases accessible to the model. Some or all object parameters can be defined with a change of value over time. These can be keyframed and interpolated or given a mathematical path and a starting translation point and velocity vector (same with rotational speed and rotational axis vector). Only when an algorithmic change happens should it be added to the event data and have the translation and rotation path updated accordingly. These algorithmic trajectories can also include acceleration, change of mass over time, battery power used, future maneuvering capability based on maneuvering to date, combinations thereof and the like.

Optionally, audio can be captured as well. Fast Fourier Transforms can be performed on the audio to check if there are any specific frequency amplitudes that are unexpected, or momentary and/or to otherwise correlate a noise or a repeating or continuous frequency with a shift in rotation or translation of the camera. In one embodiment, machine vision analysis can find regions of unidentified objects or otherwise identify background or foreground. Then, these regions are preferably packed together with describing subregion information into a quad (a 3D textured plane oriented and positioned within the scene) and a high efficiency image container (“HEIC”), high efficiency video coding (“HEVC”) and/or inline frame encoding. Unidentified objects that the model does not have a representation for can be captured as a flat texture and transmitted as pixels using existing state of the art image container formats.

If subregions stay the same over time but do translate, then those subregions can update with a predicted frame. For example, if an unidentified object translated across the screen, the small region of the screen it occupies can be transmitted once using a high efficiency image container format, and then subsequent frames could simply describe how this “unidentified object” moved through the scene. Thus, sometimes the process can fall back to describing a subregion of the scene as pixels, if it contains an object for which it cannot describe or render. Optionally, the packed subframe can change in resolution over time. Alternatively, each new object rectangular region can be HEVC encoded over time, while trying to maintain the width, height, or other size. The rectangular region can also be masked to the detected object edge to further reduce encoding overhead.

The analysis of these regions of pixel data preferably includes separating structure from texture. This can optionally be done via assessing diffuse lighting changes in context to the known lighting direction and comparing the perspective shape of edges and shapes of the object. Variations in color vs luminosity can be used to inform more about texture than the geometry.

Embodiments of the present invention can be used for live streaming. Optionally, this can include the use of feedback to provide information about available bandwidth. For example, in a space-based use case, this can include for example feedback from ground control or another satellite transceiver. Optionally this can be detected via analytics on the received data from the decoder, information about which can then be sent back to the encoder/encoder such that it can adjust its transmission bitrate accordingly.

The time it takes for performing 2D rendering, the comparison operation between the render and the real camera captured frame, the updating of the simulated world parameters, and the operation of compression, can be done in real-time for live video streaming; however, the video can optionally be encoded in standard video compression methods (for example AVC, HEVC, AV1, combinations thereof and the like) and saved, and then later the recorded video file can be opened and decoded, and can be reencoded. This can be done in faster than real-time (assuming of course that the selected hardware is capable of meeting the performance goals of such real-time applications), after which it can be saved in the desired file format, or it can be slower than real-time in order to improve the 2D rendering real world replication (for example with reflection ray-tracing enabled), to improve the comparison operation of the real world frame with the rendered frame, and to improve on the compression operation. In one embodiment, it can be done again at real-time in order to restream the video.

During periods where there is known to be insufficient or no connectivity with a decoder, the encoder can do deep non-real-time post processing on a recorded video stream in order to optimize predictivity and event analysis to improve compression and prioritization accordingly. Although the processing (retraining) required to perform this update to the 4D model might be intense, the resulting update in the syntax of a 3D geometric object, surface textures and light sources, will likely be small and simple and will be easy to communicate to the decoder once connectivity is reestablished.

In one embodiment, feedback to the encoder/encoder is also provided of regarding dropped packets, which can include for example advising the encoder of a ratio of dropped packets to recovered packets over time in order for the encoder to perform adaptive forward error correction (“FEC”) and/or otherwise adjust transmission parameters dynamically. This can be helpful for low latency when there is no time to perform retry request and can help mitigate packet loss—especially for environments with unreliable transmission channels. If there is no ability for the decoder to communicate back to the encoder, then a pre-evaluated FEC ratio with packed messaging up to a maximum threshold delay is preferably used and a maximum threshold for the bitrate is also preferably set. The FEC used is preferably hardware dependent based on real-time constraints—ideally, Reed Solomon FEC is used to maximize algorithmic recovery, and ideally, delayed encoder buffering to maximize packet packing to, in turn, maximize Reed Solomon K for K/N in order to be able to recover burst packet sequence drops. Alternatively, COP3 FEC can be used on less capable hardware if needed or otherwise desired.

Optionally hyper realism through super-resolution or high dynamic range lighting rendering can be provided such that known regions of the scene can be rendered at higher resolutions or better illumination than what was actually available in the captured image, thus enhancing detail without additional bandwidth. Optionally, the decoder can provide enhanced playback capabilities, whereby the decoder can manipulate, or otherwise allow the user to manipulate, the rendered scene, allowing for changes in viewpoint, lighting conditions, and object emphasis. This is particularly useful for interactive applications—for example surveillance and/or analysis. By modeling object trajectories and behaviors, the system can predict future positions and events, aiding in proactive monitoring.

If the bitrate and drop rate are known ahead of time by encoder and decoder respective positions over time, then the bitrate and FEC can follow algorithmic adjustments—this preferably happens preemptively and preferably filter update when there is feedback from the decoder—even if the feedback is delayed by a long duration (the received bitrate and drop rate are preferably time stamped on the decoder along with its respective position and rotation and other parameter metrics and other data). If there is additional information that the decoder and/or encoder is aware of, which can include for example weather conditions or temporary occlusion from known objects being in the way, these are preferably taken into account for the forthcoming predictions. Furthermore, the amount of FEC is preferably proportional to the importance of the sent data packets—the metric of importance can be algorithmically determined based on the deviation from predictability, the severity of the real world condition captured, and the interdependency from previous stream data.

When bandwidth constraints exist, the frequency of parameter and/or trajectory update information and delta frame new object geometry and texture information is preferably reduced. Optionally, the texture scale and geometry vertex count can be reduced to make efficient use of available bandwidth.

Even though there is adaptivity on encoding bitrates and resolution and framerate and FEC, the original video capture can concurrently be saved in high quality resolution and bitrate and framerate—this can be adaptively reencoded later for retransmission or retrieval on command. It can also be concurrently transmitted to a different destination (for example a different satellite or different ground station decoder) that independently might have different bandwidth and transmission failure rates. And if there is concurrent multipath transmission capabilities to a destination, then adaptive prioritized FEC and bandwidth bonding can be implemented to cumulatively maximize redundancy, and/or total bandwidth for maximizing quality.

For post analysis and non-real-time optimization, during periods where there is known to be no connectivity with a decoder, the encoder/encoder can do deep non-real-time post processing on a recorded video stream in order to optimize predictivity and event analysis to improve compression and prioritization accordingly.

Negative biased model compression is a technique for compressing real-time video by transmitting only the significant, unpredictable changes in a scene, rather than the entire image. Instead of relying on traditional pixel-based statistical analysis, it uses an AI 4D model that includes detailed information about the scene, such as object positions, observer properties, and kinematics, to predict what the scene should look like at a specific moment in the near future, from any arbitrary vantage point. The process can include
Model Prediction: The AI model renders an expected image (“M0”) of the scene, based on a 4D dynamic model, slightly ahead of the actual capture time.
Comparison: The expected image is compared with the actual image (“ME”) captured by the camera, using techniques like subtraction and image correlation.
Difference Analysis: Differences between the two images are identified, and a heat map is created to highlight significant changes.
Noise Filtering: The heat map is preferably filtered to remove noise, focusing on anomalies or differences that stand out due to their unpredictability, thus identifying regions of Interest (“ROIs”). Once an ROI is isolated, the system preferably compresses and transmits only that portion of the frame, thus providing more efficient compression.
In one embodiment the ROI can be transmitted along with metadata about the model and camera settings.
Reconstruction: At the decoder, the scene is reconstructed by rendering the expected image and overlaying the received ROIs. This allows for detailed analysis of the scene with minimal bandwidth usage.

The rendering engine can preferably replicate different camera optical and sensor characteristics to ensure that the predicted frames closely match the actual captured frames. For example, Field of View (“FOV”) and distortion can be replicated by the engine replicating the real camera lens FOV, including fisheye distortion, chromatic aberration, and vignetting.

In one embodiment, commercial off the shelf game rendering engines can be used. These can include for example the UNREAL engine by Epic Games, or the UNITY engine by Unity Technologies, for high speed. Optionally, however, a photorealistic emphasis can be provided by an engine like the BLENDER gaming engine by Blender Foundation. Optionally, an integrated tool like Nvidia Corporation's OMNIVERSE can be used for up to date models. Another option, the QT gaming engine is quite popular on embedded units and can be used. Yet another option that can be used is a rendering framework like VULKAN by The Khronos Group, Inc. to create a more efficient “bare bones” engine. Optionally, a combination of two or more of the above can optionally be used—for example UNREAL on a tablet computer and UNITY on a personal computer, with OMNIVERSE in the cloud and a bare bones system using VULCAN can be based on the edge—which can include for example in the camera itself. The model can be set up in a format that can include for example Universal Scene Description (“USD”), so that most of the engines will support it, and if it is done with care, all the renderers will result in the same output image.

The model not only describes the 3D objects' geometrics, but also the physics, and the movement of the objects in the scene—thus a 4D of reality. The model can be preloaded in the edge computer for the encoder before separating the edge computer from the base computer—for example the decoder computer; or the model can be uploaded and/or updated to the remote computer after separation. During operation, the two systems are synchronized (preferably with precisely synchronized clocks—for example described in Universal Time). On the encoder side, the time plus the exact kinematic information (location, orientation, speed-read from onboard inertial measurement unit (“IMU”) or global positioning system (“GPS”) is entered into the model, to render a frame. The kinematic information is then transmitted with the “delta frame” to the ground. This allows the decoder to then “calculate” and reconstruct the exact same background frame that the encoder saw at any given time, as a background, and the decoder then pastes the “delta frame” on top of the background.

The engine can also preferably simulate real-world aperture behavior, including starburst diffraction from the number and shape of aperture blades and dynamic depth of field (“DOF”), light capture and diffraction patterns. This ensures that the rendered scene matches captured images.

Camera Characteristics: The engine preferably simulates behavior of the camera, including for example for sensor resolution, frame rate, exposure time (affecting motion blur), and sensor type—including for example charge-coupled devices (“CCD”), complementary metal-oxide-semiconductor (“CMOS”), event-based sensors (“EBS”), combinations thereof and the like. It can preferably simulate characteristics that can include color or monochromatic image captures based on color response—for example red, blue, green (“RGB”) or grayscale sensors. The engine can also preferably account for noise patterns and optionally for sensor hot and/or dead pixels.

Lighting replications are preferably accommodated (most preferably by the rendering engine), which can include modeling expected lighting types (point lights, directional lights, area lights, and ambient lighting). Other dynamic parameters, which can include for example, color, intensity/brightness, attenuation, and position are also preferably modeled by the rendering engine, thus matching the real-world light sources to ensure accurate illumination in the rendered model.

The rendering engine can also preferably provide scene parameter updates by dynamically updating scene characteristics as objects, lights, and cameras change in real-time, reflecting adjustments in translation, rotation, and object-specific parameters. Embodiments of the present invention preferably model global illumination, which can include reflection ray tracing, and subsurface scattering to better model effects observed by a camera recording the actual scene. Fluid and cloth dynamics, as well as rigid body collision detection, can be simplified through predefined paths.

For determining predefined paths, the trajectory of objects moving through space is determined by their orbits—typically described by a Two Line Element (“TLE”). These elements can be constructed from a single measurement of position (typically relative to the Earth), and velocity. From that point on, the object will follow a predicted and determined path, unless acted on by an outside force. If the maneuver is known to take place (for example, as part of a satellite's concept of operations), then the TLE can be updated internally. If the maneuver is not known, leading to the object appearing (or not appearing) in a surprising place, the new detected position and velocity can be used to estimate the new TLE. These same principles of propagating motion based on physical laws can apply to many non-space domains as well. For satellites, their maneuvers are typically planned out weeks in advance, and this information can act as input into the model. Further, sensors like IMUs or star trackers can be used to measure the rotation and orientation of the craft directly. When unpredictability exists, real-time frame analysis is used to update the 4D scene model by comparing the rendered and camera-captured frames, updates parameters accordingly.

The below-described scene dynamic and frame analysis algorithms are preferably used to compare the rendered frames to real camera captures—optionally this can be done by algorithms of the engine. Differences between the two can lead to updates in the global time, object paths, rotations, velocities, and even the introduction of new objects into the scene. The algorithms preferably include one or more of the following:
Global Time and Rate Adjustments: If all objects exhibit a uniform temporal offset, the global time or rate is preferably adjusted accordingly;
Object-Specific Adjustments: For objects that deviate from their expected path or rotation, translations, velocities, and accelerations are updated;
Path Prediction: Predictive models are used for rigid body objects, especially in cases like satellites in known orbits, to minimize real-time computational overhead; and/or
Real-Time Object Identification: New objects detected in the scene are analyzed and their geometry is accumulated over time. Predictive algorithms assist in recognizing expected shapes (e.g., satellites) and textures (this can include, for example, solar panels, reflective surfaces).

Embodiments of the present invention preferably provide predictive object modeling. Space-based scenes are often predictable, allowing for the efficient modeling of new objects as combinations of known geometric shapes and textures. This database-driven approach enables rapid adaptation to new objects detected by the camera system. In one embodiment, objects are initially modeled as simplified geometric primitives (for example, rectangular prisms for satellite bodies, disks for solar panels). Over time, the texture of new objects is accumulated and thus built up based on their changing views and lighting conditions.

Given bandwidth constraints, the engine employs sophisticated compression techniques that can include one or more of:
Object-Based Compression: In this embodiment, object types are preferably indexed, and their parameters, which can include for example texture, position, and rotation, are preferably Huffman encoded based on the likelihood of change.
Dynamic Texture Simplification: High-frequency, low-relevance textures—for example grass on a sports field, can be simplified or replaced with generic textures without impacting viewer perception.

Embodiments of the present invention can be adapted for live streaming—for example by providing region-based encoding where subregions of frames that contain new or unknown objects are dynamically encoded, with resolution and detail changing as needed over time. Embodiments of the present invention preferably adapt to real-time streaming conditions by adjusting encoding bandwidth, frame rates, and forward error correction of the encoded regions of difference based on feedback from the decoder. Bitrate and encoding parameters can be adjusted in response to network conditions, thus ensuring optimal use of available bandwidth.

Embodiments of the present invention reduce bandwidth by only transmitting unpredictable changes in the scene. Embodiments of the present invention also save power by performing rendering and comparison in a graphics processing unit (“GPU”), which can be located at the edge. The reconstructed image retains full context, enabling deeper analysis by the decoder.

Optionally, an embodiment of the present invention can include a method for streamlining video compression using digital twin data. Embodiments of the present invention improves efficiency of image and video compression by replacing only traditional I-frames (key frames) with Digital Twin I-frames (“DTI-frames”), only the P-frames with Digital Twin P-Frames (“DTP-frames”), or any combination of both.

In one embodiment, instead of capturing I-frames pixel by pixel, pre-rendered photo-realistic model of the scene (a “digital twin”) is preferably used. This model can include depth maps, surface textures, lighting, and shadows, similar to game engine rendering. DTI-frames require less data to store and/or transmit because they describe the scene rather than capture every pixel thereof. If the scene is predictable (for example static vantage points), the model can be pre-stored at both encoder and decoder, reducing the need for transmission. Key advantages can include bandwidth savings by reducing the size of I-frames, thus saving bandwidth and/or storage space. The DTI-frame is less or not at all affected by lighting changes, atmospheric conditions, and imperfections in the camera system (for example, lens distortions and noise). Once re-created, DTI-frames can be treated like traditional I-frames by standard decoders, thus ensuring compatibility with existing video pipelines. Depending on scene changes, it can also be easier to implement variable frame rates and GOP sizes using embodiments of the present invention. The differences between DTI-frames and actual frames can be analyzed to detect new objects, refine the model, or ignore unimportant variations. Embodiments of the present invention are particularly useful in surveillance, security, and/or monitoring applications—especially with wireless transmission.

Embodiments of the present invention offer a more efficient video compression system by combining traditional compression with advanced synchronized 4D modeling, and photo-realistic rendering, thus making it especially effective in predictable scenes. Embodiments leverage a model-based approach to replace resource-intensive I-frames, or numerous P-Frame only resulting from predictable movement of predictable objects with more compact, model-generated frames, thus resulting in significant data savings and improved resilience against environmental factors.

Although embodiments of the present invention can be useful in virtually any desired application, the following list illustrates use-cases in which embodiments of the present invention can provide particularly desirable results:
1) Space: Ideal for star fields, planets, moons, and satellites where bandwidth is limited, and objects are well known and often follow extremely predictable paths, orbits, and/or rotations. As a specific example, satellites can use embodiments of the present invention to transmit significant events (for example debris or unknown satellites) while ignoring predictable celestial movements, shadows on the spacecraft itself, or movement on the earth due to its rotation.
2) Surveillance Systems: Embodiments of the present invention can enhance monitoring capabilities by efficiently storing and/or transmitting only significant changes, helping to identify real-world events as significant, and also enabling enhanced interactive review and/or playback. Because embodiment of the present invention differentiate based predictability of objects and their expected movements, if a new object or motion occurs that was not predicted, it can be identified as difference data and can illustrate a potential security event of noteworthiness. As a specific example, when used in systems like doorbell cameras, the present invention can provide the ability for the doorbell camera system to recognize and transmit only new, significant changes (for example a person entering a yard), thus reducing storage and bandwidth use by ignoring routine background movements like a tree swaying.
3) Live Event Broadcasting, including Video Calls: Reduces bandwidth and increases video quality for streaming events by focusing on essential scene elements, like sports players on a court or field, or newscasters on a set, or race cars on a track, and having the static objects of the set, field, court, or track being separately referenced as 3D scene object geometry and texture assets.
4) Manufacturing and Robotics: Cameras in manufacturing plants can focus only on anomalies—like defects in a product while ignoring expected conditions, reducing the need for constant data transmission.
5) Computer Vision Applications: Embodiments of the present invention allow efficient analysis of large image datasets by focusing processing power only on regions of interest. This is beneficial for both real-time operations (for example autonomous vehicle navigation) and post-event analysis (for example forensic investigation).
6) Video Processing: Embodiments of the present invention can also provide significant benefits in post-processing, video editing, compression, and analysis, thus allowing for more efficient workflows by focusing only on areas of interest without needing to process entire frames.

The foregoing examples are not at all exhaustive and are merely given to provide the reader with some illustrative examples of use-cases that are possible with embodiments of the present invention.

Optionally, embodiments of the present invention can include a general or specific purpose computer or distributed system programmed with computer software implementing steps described above, which computer software may be in any appropriate computer language, including but not limited to C, C++, FORTRAN, BASIC, Java, Python, Linux, assembly language, microcode, distributed programming languages, combinations thereof and the like. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

The terms, “a”, “an”, “the”, and “said” mean “one or more” unless context explicitly dictates otherwise. Note that in the specification and claims, “about”, “approximately”, and/or “substantially” means within twenty percent (20%) of the amount, value, or condition given. All computer software disclosed herein may be embodied on any non-transitory computer-readable medium including combinations of mediums.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A data compression method comprising:
obtaining a representation of an actual scene with a sensor;
generating a representation of an expected scene with a model;
comparing the representation of the actual scene with the representation of the expected scene; and
obtaining difference data from the comparison, the difference data representing a difference between the representation of the actual scene and the representation of the expected scene.

2. The data compression method of claim 1 wherein obtaining difference data comprises ignoring differences between the representation of the actual scene and the representation of the representation of the expected scene that are determined to be unimportant information.

3. The data compression method of claim 2 wherein unimportant information comprises high-frequency, low-relevance texture data.

4. The data compression method of claim 3 further comprising replacing at least some of the unimportant information with representative texture data that is pre-modeled and pre-stored.

5. The data compression method of claim 1 wherein at least some of the difference data is used to form a region of interest, that is a subset of the generated representation of an expected scene, for subsequent compression using either intra-frame compression or inter-frame compression in a temporal compression method.

6. The data compression method of claim 1 further comprising storing or transmitting at least some of the difference data.

7. The data compression method of claim 6 wherein the method does not include transmitting or storing an entirety of the representation of the actual scene when the difference data does not comprise the entirety of the representation of the actual scene.

8. The data compression method of claim 6 further comprising decompressing data by receiving or otherwise obtaining the at least some of the difference data and creating a recipient-generated representation of the expected scene with the at least some of the difference data, at least some metadata that describes how difference data was obtained, and a prior copy of the model.

9. The data compression method of claim 6 wherein the at least some of the difference data does not include difference data that was determined to be unimportant information.

10. The data compression method of claim 6 further comprising applying indicia on or about an area of the recipient-generated representation of the expected scene to highlight or otherwise identify the at least some of the difference data.

11. The data compression method of claim 1 wherein generating a representation of an expected scene comprises using a three-dimensional rendering engine that models the sensor.

12. The data compression method of claim 1 wherein generating a representation of an expected scene comprises using a three-dimensional rendering engine that models the characteristics of the representation of the actual scene.

13. The data compression method of claim 1 wherein generating a representation of an expected scene comprises applying one or more elements selected from a list consisting of sensor resolution, frame rate, exposure time, sensor type and a combination thereof.

14. The data compression method of claim 1 further comprising updating the model.

15. The data compression method of claim 1 wherein generating a representation of an expected scene with a model comprises generating a representation of an expected scene with a model for a predetermined application, wherein the model is constructed with one or more predetermined likely to be present objects and shapes and wherein the predetermination comprises not choosing objects or shapes that are not likely to be encountered in the predetermined application.

16. Computer software stored on a non-transitory computer readable medium for data compression comprising:
code obtaining a representation of an actual scene with a sensor;
code generating a representation of an expected scene with a model;
code comparing the representation of the actual scene with the representation of the excepted scene; and
code obtaining difference data from the comparison, the difference data representing a difference between the representation of the actual scene and the representation of the expected scene.

17. The computer software of claim 16 wherein code obtaining difference data comprises code ignoring differences between the representation of the actual scene and the representation of the expected scene that are determined to be unimportant information.

18. The computer software of claim 17 further comprising code that determines that high-frequency, low-relevance texture data is unimportant information.

19. The computer software of claim 16 further comprising code storing or transmitting at least some of the difference data.

20. The computer software of claim 16 further comprising code decompressing data by receiving or otherwise obtaining at least some of the difference data and code creating a recipient-generated representation of the expected scene with the at least some of the difference data and model.

21. The computer software of claim 16 further comprising code applying indicia on or about an area of the recipient-generated expected scene to highlight or otherwise identify the at least some of the difference data.
